(19) United States
(12) Patent Application Publication
(10) Pub. No.: US 2005/0240397 A1
(43) Pub. Date: Oct. 27, 2005

(54) Method of determining variable-length frame for speech signal preprocessing and speech signal preprocessing method and device using the same

(75) Inventor: Bum-Ki Jeon, Seongnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/111,941

(22) Filed: Apr. 22, 2005

(30) Foreign Application Priority Data
Apr. 22, 2004 (KR) 27998/2004

(51) Int. Cl. G10L 19/04

(52) U.S. Cl. 704/219

(57) ABSTRACT

Disclosed are a device and a method of determining a variable-length frame for speech signal preprocessing, which can improve performance of speech signal processing during a speech signal preprocessing procedure, and a speech signal preprocessing method and device using such a preprocessing method. The preprocessing method includes the steps of converting the input speech signal into a digital speech signal, varying a frame length of the speech signal and simultaneously calculating an LPC residual error from frame length to frame length, and determining a length of the current frame by taking a frame length at which the LPC residual error is minimal. The speech signal preprocessing method and device use the processing method uses a variable-length frame. These methods and device can extract a more accurate feature vector, thereby preventing lower recognition in performance during speech signal processing.

### PRIORITY

This application claims to the benefit under 35 U.S.C. §119(a) of an application entitled “Method of Determining Variable-Length Frame for Speech Signal Preprocessing and Speech Signal Preprocessing Method/Device Using the Same” filed in the Korean Industrial Property Office on Apr. 22, 2004 and assigned Serial No. 2004-27998, the entire contents of which are hereby incorporated by reference.

### BACKGROUND OF THE INVENTION

1. Field of the Invention

The present invention relates to a method and a device for speech signal processing. More particularly, the present invention relates to a method of determining a variable-length frame for speech signal preprocessing, which can improve the performance of speech signal processing during a speech signal preprocessing procedure, and a speech signal preprocessing method and device using such a determining method.

2. Description of the Related Art

Digital speech signal processing is generally used in various application fields such as speech recognition for causing a computer device or a communication device to recognize analog human speech, Text-to-Speech (TTS) for synthesizing sentences into human speech through a computer device or a communication device, speech coding and so forth. Such a speech signal processing is now in the spotlight as an elemental technology for a Human Computer Interface, and its application is being gradually extended to various fields to make human life easier, including home automation, communication equipment, such as speech recognition mobile phones, and speaking robots.

Digital speech signal processing requires a preprocessing procedure for extracting a speech signal characteristic, and this preprocessing procedure plays an important role in controlling the quality of the digital speech signal. Such a speech signal preprocessing procedure is usually carried out as described below.

In the speech signal preprocessing procedure, an analog speech signal is converted into a digital speech signal, and the converted speech signal is subjected to pre-emphasis processing to emphasize a high-frequency band component thereof. Thereafter, framing processing for dividing the speech signal into a plurality of frames each having a constant time intervals is performed, hamming window processing is performed so as to minimize any discontinuous section of each divided frame, and then a feature vector representing a speech signal characteristic is extracted.

In the aforementioned preprocessing procedure, the framing processing is performed on the assumption that the speech signal has a constant frequency characteristic within a short interval, and the feature vector is extracted every frame divided at constant time intervals. However, when the feature vector is extracted using the fixed-length frame as stated above, there is a drawback in that an inaccurate feature vector may be extracted due to a spectrum resolution problem, which causes lowering in performance of speech signal processing using such a feature vector.

That is, in the conventional speech signal processing technique, the framing processing is performed by dividing a speech signal into frames having a fixed length selected from a range of 20 ms to 45 ms, where the speech signal is generally considered to have a constant frequency characteristic, because it is difficult to exactly separate individual frame intervals phoneme by phoneme. In this case, a longer frame has an advantage of reducing the amount of calculation, but may deteriorate spectrum resolution and thus lead to a considerable error in a voiceless sound section. On the contrary, a shorter frame may increase spectrum resolution, but cannot accurately extract a spectrum feature vector in a long section such as a voiced sound section as compared with a longer frame having a constant frequency characteristic.

In other words, when a fixed-length frame is used for the framing processing, an inaccurate feature vector may be extracted due to the spectrum resolution problem, which results in a lower performance of speech signal processing. To conclude, it is very important to extract an accurate feature vector and thus an efficient speech signal preprocessing scheme for developing such a scheme is strongly desired.

### SUMMARY OF THE INVENTION

Accordingly, the present invention has been made to solve the above-mentioned problems occurring in the prior art. An object of the present invention is to provide a method of determining a variable-length frame for speech signal preprocessing, which can improve the performance of speech signal processing.

A further object of the present invention is to provide a speech signal preprocessing method and device using a variable-length frame, which enables an accurate feature vector to be extracted by dividing a speech signal into variable-length frames.

To accomplish the former object of the present invention, there is provided a frame processing method for dividing a speech signal into a plurality of frames in order to extract a feature vector of an input speech signal in accordance with an aspect of the present invention, the method comprising the steps of (1) converting the input speech signal into a digital speech signal; (2) varying a frame length of the speech signal and simultaneously calculating a Linear Prediction Coefficient (LPC) residual error from frame length to frame length; and (3) determining a length of the current frame by taking a frame length at which the LPC residual error is minimal.

To accomplish the latter object of the present invention, there is provided a speech signal preprocessing method for extracting a feature vector of a speech signal, the method comprising the steps of (1) converting an input speech signal into a digital signal; (2) performing pre-emphasis filtering for emphasizing a high-frequency band of the speech signal; (3) varying a frame length of the speech signal and simultaneously calculating a Linear Prediction Coefficient (LPC) residual error from frame length to frame length; (4) determining a length of each frame by taking a frame length at which the LPC residual error is minimal; and (5) extracting a feature vector of the speech signal from each frame.

To accomplish the latter object of the present invention, there is also provided a speech signal preprocessing device comprising an analog-to-digital (AD)converter for converting an input speech signal into a digital signal; a pre-emphasis filter for performing pre-emphasis filtering which emphasizes a high-frequency band of the speech signal; a framing processor for varying a frame length of the speech signal and simultaneously calculating a Linear Prediction Coefficient (LPC) residual error from frame length to frame length, and determining a length of each frame by taking a frame length at which the LPC residual error is minimal; and a feature vector extractor for extracting a feature vector from each frame.

### BRIEF DESCRIPTION OF THE DRAWINGS

The above and other objects, features and advantages of the present invention will be more apparent from the following detailed description taken in conjunction with the accompanying drawings, in which:

FIG. 1 is a flowchart of a speech signal preprocessing method using a variable-length frame in accordance with an embodiment of the present invention;

FIG. 2 is a flowchart of a method for determining a variable-length frame for speech signal preprocessing in accordance with an embodiment of the present invention;

FIG. 3 is a block diagram showing a construction of a speech signal preprocessing device using a variable-length frame in accordance with an embodiment of the present invention; and

FIGS. 4a to 4c are graphs showing test results obtained when the methods and the device according to embodiments of the present invention are applied to speech recognition.

Throughout the drawings, it should be understood that similar reference numbers refer to like features, structures and elements.

### DETAILED DESCRIPTION OF EXEMPLARY EMBODIMENTS

Hereinafter, exemplary embodiments of the present invention will be described with reference to the accompanying drawings. Further, in the following description of the present invention, a detailed description of known functions and configurations incorporated herein will be omitted for the sake of clarity and convenience. Also, for convenience's sake, a speech signal preprocessing method according to the present invention will be described below by illustrating speech recognition from among speech signal processing fields by way of example.

According to an embodiment of the present invention, first of all, a frame for extracting a feature vector of a speech signal is set as having a variable length. Also, the present invention proposes a speech signal preprocessing method comprising a procedure of determining a frame length, in which a Linear Prediction Coefficient (hereinafter referred to as ‘LPC’) residual error of a frame is calculated and a length of the relevant frame is determined by taking a frame length at which the LPC residual error is minimal.

Since a frame length is set as variable in embodiments of the present invention, the magnitudes of feature vectors extracted from individual frames are not constant. Accordingly, embodiments of the present invention also propose a speech signal preprocessing method in which a similarity result of each frame is normalized by applying a linear weighting value. In addition, embodiments of the present invention provide a new delta Cepstrum technique for enabling a Cepstrum technique, which analyzes periodicity of a frequency spectrum of a speech signal and represent a feature vector for each frame based upon the periodicity, to be applied to the variable-length frame.

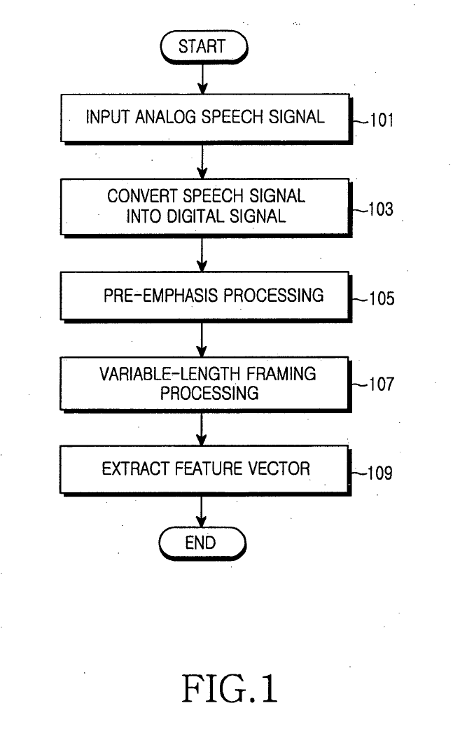

FIG. 1 illustrates a flowchart for a speech signal preprocessing method using a variable-length frame in accordance with a preferred embodiment of the present invention.

First, if an analog speech signal to be subjected to a speech signal preprocessing is input at step 101, an A/D conversion is performed at step 103 to convert the input analog speech signal into a digital signal. Subsequently, pre-emphasis processing is carried out at step 105 to emphasize a high-frequency band component of the speech signal that has been converted into the digital signal. Also, framing processing is performed at step 107 by varying a length of each frame such that an LPC residual error of the relevant frame is minimal. A feature vector of the speech signal is extracted from each frame at step 109. In this way, the speech signal preprocessing is completed.

Herein, steps 101 to 105 in FIG. 1 will not be described in detail because a conventional scheme is used in these steps. Hereinafter, a detailed description will be given first for the variable-length framing processing procedure of an embodiment of the present invention according to step 107, and then a further description will be given for a feature vector extracting scheme of an embodiment of the present invention which is applied to the variable-length frame according to step 109.

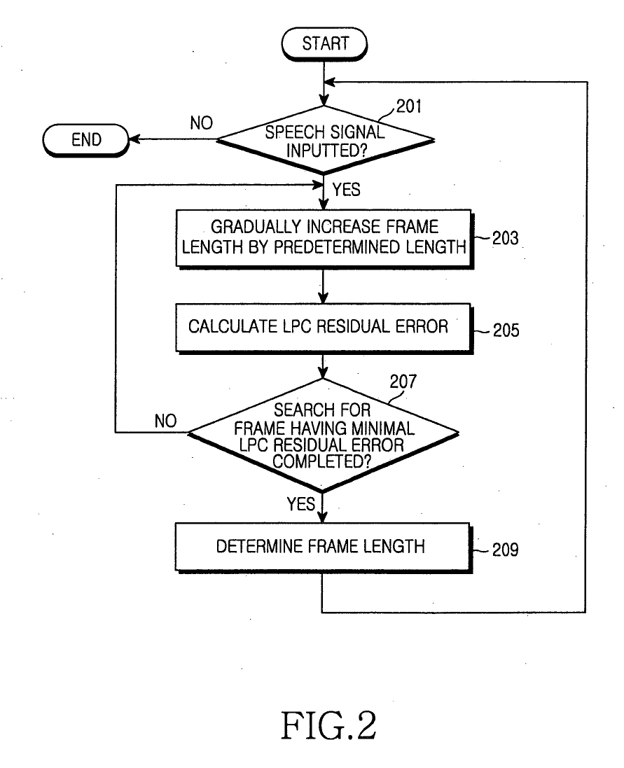

FIG. 2 illustrates a flowchart of a method for determining a variable-length frame for speech signal preprocessing in accordance with an embodiment of the present invention, that is, the framing processing procedure which is carried out at step 107 shown in FIG. 1.

If a speech signal, which has been subjected to the pre-emphasis processing according to step 105 in FIG. 1, is input at step 201, a frame length at which an LPC residual error has a minimum is sought while gradationally increasing a length of each frame through steps 203 to 207, and steps 203 to 207 are repeated until a frame length at which the LPC residual error has a minimum is finally sought out for the relevant frame. The LPC residual error signifies an error which is generated when an LPC of a speech signal is measured (or calculated). If an overlapping window is preferably used for deriving the LPC residual error, the LPC residual errors of frames are calculated using a midpoint of a previous frame as a staring point of the current frame LPC residual error which is being measured.

In the frame length setting method proposed according to an embodiment of the present invention, for example, a frame length starts with 20 ms and is gradationally increased by 5 ms to 45 ms. For all frame lengths gradationally increased by 5 ms, an LPC residual error is calculated from frame length to frame length using a Levinson-Durbin algorithm as defined below by Equation (1), and then a frame length at which the LPC residual error has a minimum is sought. For example, after a speech signal having a length of 45 ms is stored in a buffer (not shown), a frame length starting with 20 ms is gradationally increased to 25 ms, 30 ms, 35 ms, 40 ms and 45 ms, and simultaneously LPC residual errors are calculated for all frames having the respective frame lengths within the corresponding range. From among the frame lengths, a frame length at which the LPC residual error has a minimum is sought.

The lower limit (20 ms) and the upper limit (45 ms) of the frame length are chosen here because a range between the lower and upper limits is usually used for speech signal processing, and it is possible to selectively increase or decrease the length of the range.

The aforementioned Levinson-Durbin algorithm can be defined by Equation (1) as follows:
E⁽ⁱ⁾=(1−kᵢ²)E⁽ⁱ⁻¹⁾ Equation (1)
where, E⁽ⁱ⁾ denotes an LPC residual error generated through the i-th degree modeling, and kᵢ denotes a PARCOR coefficient.

The PARCOR coefficient in Equation (1) is defined by Equation (2) as follows:

$${k}_{i} = \frac{r ( i ) - {\sum }_{j = 1}^{L - 1} {α}_{j}^{( i - 1 )} r ( \vert i - j \vert )}{{E}^{( i - 1 )}} , 0 \leq i \leq p \qquad Equation ( 2 )$$

where, r(i) is an autocorrelation function, α denotes an Linear Prediction Coefficient (LPC), and E⁽ⁱ⁾ in Equation (1) and r(i) has a relation of E⁽⁰⁾=r(0). The LPC α is defined by Equation (3) as follows:

$$\begin{matrix}{α}_{i}^{( i )} = {k}_{i} \\ {α}_{j}^{( i )} = {α}_{j}^{( i - 1 )} - {k}_{i} {α}_{i - j}^{( i - 1 )}\end{matrix} \qquad Equation ( 3 )$$

where, αⱼ⁽ⁱ⁾ denotes the j-th LPC of i-th order, and αⱼ^{(p)} to be finally calculated becomes the j-th LPC of p-th order. Using Equations (1) to (3), a frame length at which the LPC residual error is minimal can be sought out frame by frame.

The LPC residual error signifies a degree of spectrum inconsistency, and a feature vector for the existing speech recognition is based upon spectrum information. Consequently, the feature vector can be modeled better by separating a speech signal into frames having more appropriate intervals through embodiments of the present invention.

In order to apply the variable frame technique of embodiments of the present invention to speech recognition which is judged on the basis of a cumulative similarity result of every individual frame, it is necessary to compensate for a situation where each frame length may be different. For this, a similarity result of every individual frame is normalized by obtaining a weighted variable-length frame to which a linear weighting value, wᵢ, as defined below by Equation (4) is applied according to its frame length:

$${w}_{i} = \frac{t \text{-} th frame length}{maximum frame length} \qquad Equation ( 4 )$$

where, a maximum frame length is set to 45 ms when each frame length is determined in a range of 20 ms to 45 ms or any other desired range. The linear weighting value for the t-th frame is preferably derived using the maximum frame length, but it is possible to derive the linear weighting value from a ratio of the t-th frame length to any appropriate frame length selected within a range of 20 ms to 45 ms or other desired range.

After a frame length at which the LPC residual error is minimal is sought out through the aforementioned steps, a length (distance) of the current frame is set to the sought frame length at step 209, and then the framing processing procedure proceeds to step 201 to repeat the subsequent steps for a next frame. Steps 201 to 209 are repeated until the frame lengths for all the input speech signals are determined.

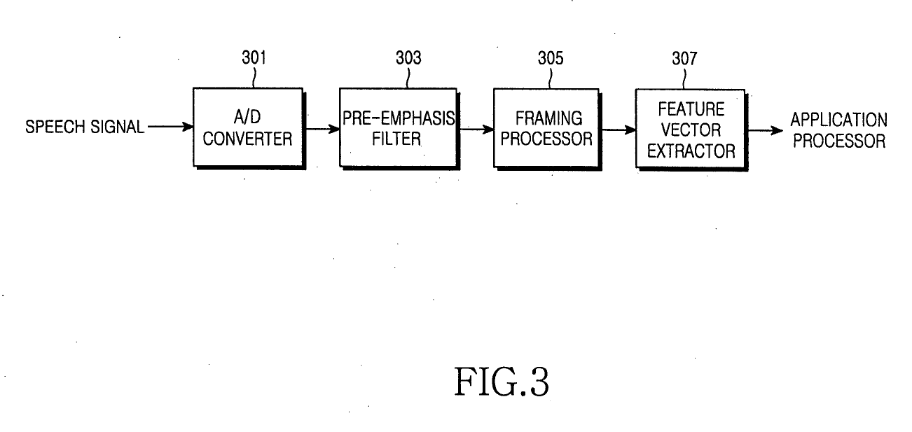

FIG. 3 illustrates a block diagram showing a construction of a speech signal preprocessing device using a variable-length frame in accordance with an embodiment of the present invention. This speech signal preprocessing device has a construction to which the speech signal preprocessing method as described in conjunction with FIGS. 1 and 2 is applied.

Referring to the construction shown in FIG. 3, an A/D converter 301 serves to convert an input speech signal into a digital speech signal and output the digital speech signal to a pre-emphasis filter 303. The pre-emphasis filter 303 filters the digital speech signal such that its high-frequency band component is emphasized, and the filtered speech signal is transferred to a framing processor 305 for dividing a speech signal into variable-length frames.

The framing processor 305 is equipped with a buffer (not shown) for storing the input speech signal by a predetermined maximum frame length. The framing processor 305 gradationally increases a frame length starting with 20 ms by 5 ms to 45 ms, and simultaneously calculates an LPC residual error from frame length to frame length using the algorithm of Equation (1). Here, the frame length for the calculation of the LPC residual error and increment of the frame length can be increased or decreased.

When the frame length at which the LPC residual error has a minimum is sought out, the framing processor 305 extracts the speech signal portion as much as the corresponding frame length and transfers the extracted speech signal portion to a feature vector extractor 307. In a case of using an overlapping window, the framing processor 305 shifts the whole non-extracted speech signal including the immediate previous extracted portion starting from a midpoint thereof to an upper address area of the buffer in order to determine a next frame length, and then a speech signal to be used for determining the next frame length is input into the empty memory locations of the buffer. It is desirable that framing processor 305 employs a plural buffer structure so as to separately perform input and output of a speech signal.

Thereafter, the feature vector extractor 307 performs hamming window processing to minimize a discontinuous section of each divided frame having a variable length, and then extracts a speech signal characteristic, that is, a feature vector. The extracted feature vector is transferred to a corresponding application processor for speech recognition, speech synthesis or speech coding.

Hereinafter, a procedure of extracting a feature vector according to an embodiment of the present invention will now be described in more detail.

First of all, there will be proposed a modification of an observation probability equation to be described below in accordance with another aspect to the present invention, by which performance of speech recognition modeling is judged in a case of applying the variable-length frame according to an embodiment of the present invention to speech recognition. In succession, a description will be given for a new delta Cepstrum technique which embodiments of the present invention proposes to represent a feature vector in the variable-length frame structure.

A time-variant characteristic of a speech signal can be easily represented by a Hidden Markov Model (hereinafter referred to as ‘HMM’) to facilitate statistical modeling for speech recognition. The HMM is one of the most widely used speech recognition algorithms, which is applied to from small-scale isolated word speech recognition to large vocabulary continuous speech recognition because it has excellent flexibility, which is advantageous.

In order to apply the method of the present invention and the variable-length frame weighted using Equation (4) to Continuous Density HMM (CDHMM), it is necessary to modify an observation probability equation of the HMM. Here, the CDHMM signifies a general technique in speech recognition, which approximates the occurrence probability of an observation signal in each state of the HMM to a normal distribution, and the occurrence probability of an observation signal is derived from the observation probability equation.

Since the observation probability equation is based upon the occurrence frequency, an estimated observation probability equation, which is modeled by approximation of actual observation probability must be changed in a modified form which is multiplied by a weighting value for normalizing a frame length. When the finally proposed method is applied to the CDHMM, the observation probability equation according to the present invention is defined by Equation (5) as follows:
bⱼₖ(Oₜ)=wₜcⱼₖN(Oₜ,μⱼₖ,Uⱼₖ) Equation (5)
where, bⱼₖ(Oₜ) denotes an observation vector, wₜ denotes a weighting value for the observation vector, cⱼₖ denotes a mixture coefficient for the k-th mixture in the j-th state, and N(Oₜ,μⱼₖ, Uⱼₖ) denotes a normal distribution probability density function (PDF) with an average vectorμⱼₖ and a variance matrix Uⱼₖ for the k-th mixture in the j-th state. In Equation (5), the weighting value defined in Equation (4) is used as the weighting value wₜ. The ‘state’ signifies a unit by which speech is subdivided into comparative units, and the ‘mixture’ signifies the degree of a multiple normal distribution when the occurrence probability of an observation signal is approximated to the multiple normal distribution.

A basic theory of the CDHMM related to Equation (3) is described in detail in Chapter 6.6 (p. 350) of L. R. Rabiner and B. H. Juang, ‘Fundamentals of Speech Recognition’, Prentice Hall (1993), incorporated herein by reference.

A parameter representing a speech signal frequency characteristic is expressed by a Cepstrum, and a typical technique to derive the Cepstrum includes an LPC Cepstrum, a mel Cepstrum, a delta Cepstrum, and the like. A brief description of the first three Cepstrum techniques is given as follows: First of all, the LPC Cepstrum is a technique in which a Cepstrum is approximated using an LPC technique because a considerable amount of calculation is required for obtaining an accurate Cepstrum. The mel Cepstrum is a technique which modifies a frequency characteristic of a Cepstrum in consideration of a scheme in which the human auditory organ separates a frequency characteristic.

Here, it should be noted that the Cepstrum can be derived using various techniques such as the LPC Cepstrum or the mel Cepstrum after the frame length at which the LPC residual error has a minimum is determined as shown in FIG. 2.

A delta Cepstrum represents change of Cepstrums extracted from plural frames whereas the LPC or mel Cepstrum represents a frequency characteristic in one frame. The delta Cepstrum is classified into a delta LPC Cepstrum and a delta mel Cepstrum according to the Cepstrum technique used. Here, the delta Cepstrum should be construed as including both the delta LPC Cepstrum and the delta mel Cepstrum.

As is well known in the art, a general feature vector expression for speech signal processing employs the delta Cepstrum technique based upon a polynomial approximation equation. Since a distance between two consecutive frames is not constant in embodiments of the present invention, the conventional delta Cepstrum calculation equation must be modified in consideration of ununiformity in the distance between adjacent frames. The derivation procedure of the modified equation is as follows:

A differential function Δc(t) of the conventional delta Cepstrum calculation equation can be obtained by approximating a trajectory of the polynomial approximation equation on a trajectory of a finite horizon. For example, let h₁ and h₂ be parameters for minimizing an error between two consecutive frames, and let t be a time of a frame interval. When a first order polynomial function of h₁+h₂t is approximated within a finite horizon t=[−M, −M+1, . . . M+1, M], the differential function Δc(t) can be obtained by deriving parameters h, and h₂ which minimize an error e(t) as defined below by Equation (6):

$$e ( t ) = {\sum }_{t = - M}^{t = M} {[ c ( t ) - ( {h}_{1} + {h}_{2} t ) ]}^{2} \qquad Equation ( 6 )$$

where, the error e(t) signifies an error which is generated in the course of modeling the above-mentioned polynomial approximation equation for plural frames.

However, since a distance between two consecutive frames is not constant due to the use of the variable-length frame in embodiments of the present invention, Equation (6) must be modified into Equation (7) as follows:

$$e ( t ) = {\sum }_{t = - M}^{t = M} {[ c ( t ) - ( {h}_{1} + {h}_{2} {l}_{t} ) ]}^{2} \qquad Equation ( 7 )$$

where, lᵢ denotes a distance indicated, preferably, in seconds between the current frame and the t-th frame. In order to derive a differential function by which the error e(t) in Equation (7) is minimized, that is, a new delta Cepstrum Δc(n), Equation (7) is differentiated with respect to h₁ and h₂, and an equation with h₁=0 and h₂=0 is established, from which Equation (8) as defined below can be derived:

$$\begin{matrix}{\sum }_{t = - M}^{t = M} = [ c ( t ) - ( {h}_{1} + {h}_{2} {l}_{t} ) ] = 0 \\ {\sum }_{t = - M}^{t = M} = [ c ( t ) {l}_{t} - ( {h}_{1} {l}_{t} + {h}_{2} {l}_{t}^{2} ) ] = 0\end{matrix} \qquad Equation ( 8 )$$

Equation (8) is easily calculated, and a first order differential function of c(n) can be derived by differentiating the approximation equation using the calculated parameters h₁ and h₂ as defined below by Equation (9):

$$Δ c ( n ) = \frac{[ \begin{matrix}{\sum }_{t = - M}^{t = M} c ( n + t ) {l}_{n} ( t ) - \frac{1}{2 M + 1} \\ {\sum }_{t = - M}^{t = M} {l}_{n} ( t ) {\sum }_{t = - M}^{t = M} c ( n + t )\end{matrix} ]}{[ {\sum }_{t = - M}^{t = M} {l}_{n}^{2} ( t ) - \frac{1}{2 M + 1} {( {\sum }_{t = - M}^{t = M} {l}_{n} ( t ) )}^{2} ]} \qquad Equation ( 9 )$$

Equation (9) is an approximation equation for calculating the delta Cepstrum using the weighted variable frame technique proposed according to embodiments of the present invention. In Equation (9), Δc(n), c(n) and lₙ(t) denote a delta Cepstrum of the n-th frame, a Cepstrum of the n-th frame and a distance between the n-th frame and (n+1)-th frame, respectively, and M denotes an interval in which change of Cepstrums extracted from plural frames. The Cepstrum of n-th frame, that is, c(n) can be derived using various Cepstrum techniques such as the LPC Cepstrum or the mel Cepstrum.

If lₙ(t) is equal to t in Equation (9), that is, a distance between two consecutive frames is constant, Equation (9) becomes the same as a general Cepstrum calculation equation as defined below by Equation (10):

$$Δ c ( n ) = \frac{{\sum }_{t = - M}^{t = M} c ( n + t ) t}{{\sum }_{t = - M}^{t = M} {t}^{2}} \qquad Equation ( 10 )$$

Accordingly, the delta Cepstrum calculation equation according to embodiments of the present invention, which is applicable when a distance between the adjacent frames is not constant can be obtained based upon the aforementioned derivation procedure.

Hereinafter, improvement in performance of speech signal processing in a case where the determining method of a variable-length frame is applied to speech recognition will be illustratively described in detail with reference to test results carried out by the present applicant.

In this test, an E-set (‘b’, ‘c’, ‘d’, ‘e’, ‘g’, ‘p’, ‘t’, ‘v’, ‘z’) selected from ‘ISOLET’ in which the English alphabet is recorded in the form of an isolated word was used as a test database, and the E-set consisted of 2700 samples corresponding to individual alphabets uttered twice by testees (75 men and 75 women). Every component of the speech of the testees is recoded at a frequency of 16 kHz and a pre-emphasis filter for emphasizing a high-frequency band signal in a preprocessing procedure performed filtering using H(z)=1−0.95z⁻¹. Also, each frame of the speech signal was subjected to the aforementioned hamming window processing and a feature vector was extracted while a window was moved by half frames.

A 12-th order LPC/mel Cepstrum and a 12-th order delta Cepstrum were used as the feature vector. Also, a CDHMM speech recognizer widely used for isolated word recognition was used as a speech recognition modeling technique, each isolated word had 4 or 5 states, and the HMM was restricted such that it has unidirectionalilty without jumping states. Samples uttered once by 120 speakers were used for HMM training, and recognition tests were performed with the other utterance samples and utterance samples of other speakers. General theories of the delta Cepstrum and the mel Cepstrum are described in detail in Chapters 4.5 (p. 189) and 4.6 (p. 196) of L. R. Rabiner and B. H. Juang, ‘Fundamentals of Speech Recognition’, Prentice Hall (1993), incorporated herein by reference.

To show the effectiveness of embodiments of the present method, a comparative test in which a feature vector is extracted using the conventional fixed-length frame was conducted under the same conditions as those of the test in which a feature vector is extracted using the variable-length frame according to embodiments of the present invention. For each test, speech recognition was tested while the number of states of HMM and the number of mixtures per state were changed. The respective test results are listed below in Tables 1 to 4. In Tables 1 to 4, ‘Training Data’ represents a recognition rate according to frame lengths after the modeling of originally input speech signal (recognition result for trained speakers), and ‘Closed Data’ and ‘Open Data’ represent a recognition result for the other samples of the trained speakers and a recognition result for other untrained speakers, respectively.

First of all, Table 1 shows a speech recognition result for the 12-th LPC Cepstrum and the 12-th delta LPC Cepstrum under the condition of 4 states and 8 mixtures.

TABLE 1

| Frame length | Training Data | Closed Data | Open Data |
|---|---|---|---|
| 20 ms | 90.9 | 72.6 | 66.9 |
| 25 ms | 92.1 | 74.3 | 68.9 |
| 30 ms | 93.0 | 76.2 | 67.2 |
| 35 ms | 92.8 | 75.9 | 68.0 |
| 40 ms | 93.5 | 75.0 | 67.8 |
| 45 ms | 92.8 | 72.1 | 63.0 |
| Fixed length | 92.5 | 74.4 | 67.0 |
| Variable length | 94.7 | 76.9 | 71.7 |

Table 2 shows a speech recognition result for the 12-th LPC Cepstrum and the 12-th delta LPC Cepstrum under the condition of 5 states and 10 mixtures.

TABLE 2

| Frame length | Training Data | Closed Data | Open Data |
|---|---|---|---|
| 20 ms | 94.4 | 70.4 | 71.9 |
| 25 ms | 95.3 | 73.4 | 68.5 |
| 30 ms | 95.9 | 74.7 | 68.0 |
| 35 ms | 96.9 | 75.9 | 66.5 |
| 40 ms | 96.1 | 73.6 | 62.8 |
| 45 ms | 96.5 | 73.6 | 61.1 |
| Fixed length | 95.8 | 73.6 | 66.5 |
| Variable length | 96.4 | 75.6 | 70.2 |

Table 3 shows a speech recognition result for the 12-th mel Cepstrum and the 12-th delta mel Cepstrum under the condition of 4 states and 8 mixtures.

TABLE 3

| Frame length | Training Data | Closed Data | Open Data |
|---|---|---|---|
| 20 ms | 93.6 | 81.9 | 76.3 |
| 25 ms | 94.6 | 83.2 | 75.0 |
| 30 ms | 94.2 | 82.5 | 75.7 |
| 35 ms | 95.3 | 81.9 | 76.9 |
| 40 ms | 93.7 | 82.1 | 74.9 |
| 45 ms | 94.6 | 82.3 | 76.5 |
| Fixed length | 94.3 | 82.3 | 75.8 |
| Variable length | 95.4 | 82.5 | 78.3 |

Table 4 shows a speech recognition result for the 12-th mel Cepstrum and the 12-th delta mel Cepstrum under the condition of 5 states and 10 mixtures.

TABLE 4

| Frame length | Training Data | Closed Data | Open Data |
|---|---|---|---|
| 20 ms | 90.9 | 72.6 | 66.9 |
| 25 ms | 92.1 | 74.3 | 68.9 |
| 30 ms | 93.0 | 76.2 | 67.2 |
| 35 ms | 92.8 | 75.9 | 68.0 |
| 40 ms | 93.5 | 75.0 | 67.8 |
| 45 ms | 92.8 | 72.1 | 63.0 |
| Fixed length | 92.5 | 74.4 | 67.0 |
| Variable length | 94.7 | 76.9 | 71.7 |

The line designated by ‘Fixed length’ represents a recognition result obtained by averaging the recognition rates according to the fixed frame lengths (for example, 20 ms, 25 ms . . . 45 ms). Tables 1 and 2 show speech recognition results tested using the 12-th LPC Cepstrum and the 12-th delta Cepstrum as a feature vector, from which it can seen that using the proposed variable-length frame provides a more accurate recognition rate result than using the fixed-length frame. Particularly, as seen in Table 1, the recognition rate obtained by using embodiments of the present invention is increased by 5% as compared with the average recognition rate obtained by the fixed-length frame, and is increased by 2.8% as compared with the recognition test result for the samples of the untrained speakers (Open Data).

In Table 2, a difference between the maximum and the minimum is 10% or more in the test for the samples of the untrained speakers (Open Data), from which the importance of the variable-length frame proposed by embodiments of the present invention can be confirmed all the more keenly. For reference, considering that it is very difficult to increase the recognition rate more than 1% in a speech recognition algorithm showing a recognition rate of 90% or more and the sensible effect of the increase in the recognition rate is considerable, improvement in performance of speech signal processing according to embodiments of the present invention can be said to be great.

Since the frame length is chosen using the LPC residual error in the embodiments of the present invention, the same test is performed for the mel Cepstrum, a typical non-LPC based feature vector in order to verify that the feature vector is also effectively extracted in the non-LPC based feature vectors, and Tables 3 and 4 shows the speech recognition results obtained using the 12-th mel Cepstrum and 12-th mel delta Cepstrum. From these test results, it can be seen that embodiments of the present invention also improves the recognition rates according to the frame lengths.

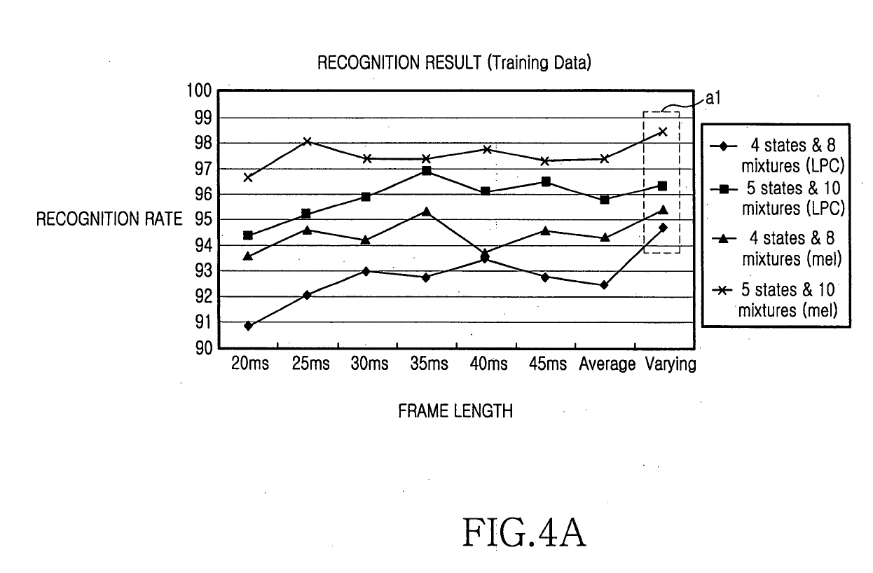

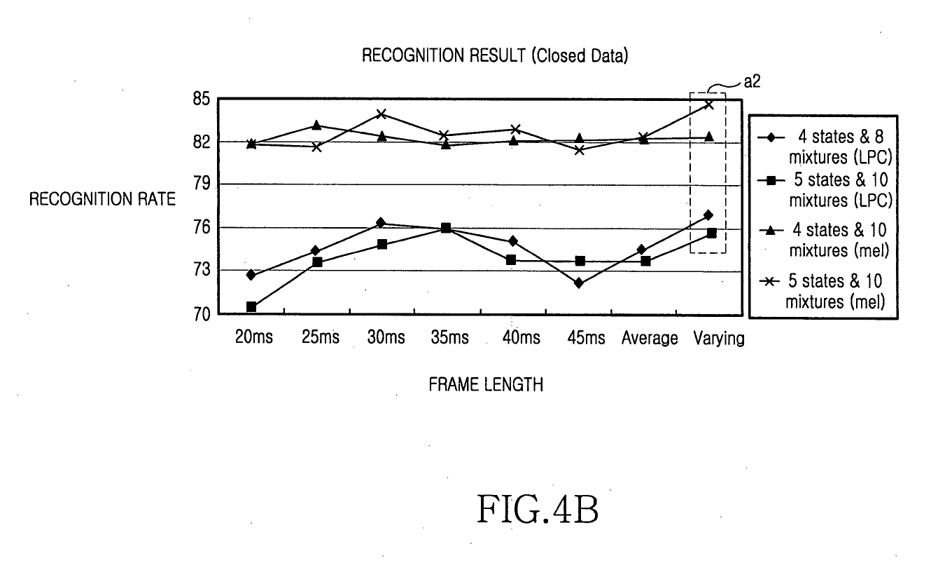

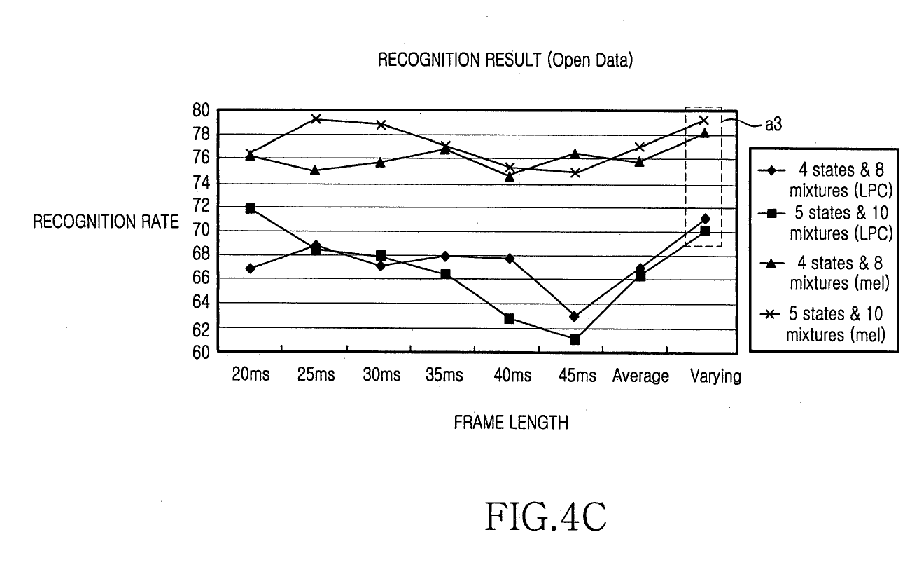

FIGS. 4a to 4c diagrammatically illustrate the test results in Tables 1 to 4 in such a manner that the test results are divided into Training Data (FIG. 4a), Closed Data (FIG. 4b) and Open Data (FIG. 4c) as described above and each divided result includes recognition rates by fixed-length frames (20 ms to 45 ms), an average recognition rate of a fixed-length frame (Average) and a recognition rate of a variable-length frame (Varying).

As described above, according to embodiments of the present invention, a frame length for speech signal preprocessing is variably determined such that an LPC residual error is minimized, thereby preventing lower performance of speech signal processing caused by the fact that an inaccurate feature vector may be extracted due to a spectrum resolution problem.

Also, the frame length is set as variable and simultaneously a similarity result of each frame is normalized by applying a linear weighting value, so that feature vectors extracted from frames having different lengths from each other can be uniformly compensated, and a new delta Cepstrum technique representing the feature vector in the variable-length frame structure can be provided.

While the invention has been shown and described with reference to certain preferred embodiments thereof, it will be understood by those skilled in the art that various changes in form and details may be made therein without departing from the spirit and scope of the invention as defined by the appended claims.

1. A frame processing method for dividing a speech signal into a plurality of frames in order to extract a feature vector of an input speech signal, the method comprising the steps of:
(1) converting the input speech signal into a digital speech signal;
(2) varying a frame length of the speech signal and simultaneously calculating a Linear Prediction Coefficient (LPC) residual error from frame length to frame length; and
(3) determining a length of the current frame by taking a frame length at which the LPC residual error is minimal.

2. The method as claimed in claim 1, wherein step (2) is repeatedly performed from a predetermined minimum frame length to a predetermined maximum frame length.

3. The method as claimed in claim 1, wherein the frame length is determined in a range of 20 ms to 45 ms.

4. The method as claimed in claim 1, further comprising the step of:
(4) multiplying the frame length determined at step (3) by a weighting value wᵢ as defined below by Equation (4):
$${w}_{i} = \frac{t \text{-} th frame length}{maximum frame length} . \qquad Equation ( 4 )$$

5. The method as claimed in claim 1, wherein a starting point of the current frame of which the LPC residual error is calculated at step (2) is set to a midpoint of the previous frame.

6. A speech signal preprocessing method for extracting a feature vector of a speech signal, the method comprising the steps of:
(1) converting an input speech signal into a digital signal;
(2) performing pre-emphasis filtering for emphasizing a high-frequency band of the speech signal;
(3) varying a frame length of the speech signal and simultaneously calculating a Linear Prediction Coefficient (LPC) residual error from frame length to frame length;
(4) determining a length of each frame by taking a frame length at which the LPC residual error is minimal; and
(5) extracting a feature vector of the speech signal from each frame.

7. The method as claimed in claim 6, wherein step (3) is repeatedly performed from a predetermined minimum frame length to a predetermined maximum frame length.

8. The method as claimed in claim 6, further comprising:
(6) multiplying the frame length determined at step (3) by a weighting value wᵢ as defined below by Equation (4):
$${w}_{i} = \frac{t \text{-} th frame length}{maximum frame length} . \qquad Equation ( 4 )$$

9. The method as claimed in claim 6, wherein at step (5), the feature vector is expressed by a delta Cepstrum as defined below by Equation (9):
$$Δ c ( n ) = \frac{[ {\sum }_{t = - M}^{t = M} c ( n + t ) {l}_{n} ( t ) - \frac{1}{2 M + 1} {\sum }_{t = - M}^{t = M} {l}_{n} ( t ) {\sum }_{t = - M}^{t = M} c ( n + t ) ]}{[ {\sum }_{t = - M}^{t = M} {l}_{n}^{2} ( t ) - \frac{1}{2 M + 1} {( {\sum }_{t = - M}^{t = M} {l}_{n} ( t ) )}^{2} ]} \qquad Equation ( 9 )$$
where, Δc(n), c(n) and lₙ(t) denote a delta Cepstrum of the n-th frame, a Cepstrum of the n-th frame and a distance between the n-th frame and (n+1)-th frame, respectively.

10. A speech signal preprocessing device comprising:
an analog-to-digital converter for converting an input speech signal into a digital signal;
a pre-emphasis filter for performing pre-emphasis filtering which emphasizes a high-frequency band of the speech signal;
a framing processor for varying a frame length of the speech signal and simultaneously calculating a Linear Prediction Coefficient (LPC) residual error from frame length to frame length, and determining a length of each frame by taking a frame length at which the LPC residual error is minimal; and
a feature vector extractor for extracting a feature vector from each frame.

11. The device as claimed in claim 10, wherein the framing processor is constructed such that it calculates the LPC residual error from a predetermined minimum frame length to a predetermined maximum frame length.

12. The device as claimed in claim 10, wherein the framing processor is further constructed such that it multiplies the determined frame length by a weighting value wᵢ as defined below by Equation (4):
$${w}_{i} = \frac{t - th frame length}{maximum frame length} . \qquad Equation ( 4 )$$

13. The device as claimed in claim 10, wherein the feature vector extractor is constructed such that it derives the feature vector using a delta Cepstrum as defined below by Equation (9):
$$Δ c ( n ) = \frac{[ {\sum }_{t = - M}^{t = M} c ( n + t ) {l}_{n} ( t ) - \frac{1}{2 M + 1} {\sum }_{t = - M}^{t = M} {l}_{n} ( t ) {\sum }_{t = - M}^{t = M} c ( n + t ) ]}{[ {\sum }_{t = - M}^{t = M} {l}_{n}^{2} ( t ) - \frac{1}{2 M + 1} {( {\sum }_{t = - M}^{t = M} {l}_{n} ( t ) )}^{2} ]} \qquad Equation ( 9 )$$
where, Δc(n), c(n) and lₙ(t) denote a delta Cepstrum of the n-th frame, a Cepstrum of the n-th frame and a distance between the n-th frame and (n+1)-th frame, respectively.
